(19) United States
(12) Patent Application Publication
(10) Pub. No.: US 2011/0291959 A1
(43) Pub. Date: Dec. 1, 2011

(54) TOUCH-TYPE TRANSPARENT KEYBOARD

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/889,589

(22) Filed: Sep. 24, 2010

(30) Foreign Application Priority Data
May 28, 2010 (CN) 201010185822.3

(51) Int. Cl. G06F 3/041

(52) U.S. Cl. 345/173

(57) ABSTRACT

A touch-type transparent keyboard is for use with an electronic device. The touch-type transparent keyboard includes a touch screen, a control module, and a transparent plate. The control module is electrically connected to the touch screen. The transparent plate includes a plurality of key icons, a driver circuit, and a metal film. The key icons are made of transparent electroluminescence material. The driver circuit is electrically connecting the key icons to the control module. When the keyboard is powered off, the metal film is used to reflect light as a mirror.

### CROSS-REFERENCE TO RELATED APPLICATIONS

This application is one of the six related co-pending U.S. patent applications listed below. All listed applications have the same assignee and were concurrently filed herewith. The disclosure of each of the listed applications is incorporated by reference into all the other listed applications.

| Attorney Docket No. | Title | Inventors |
|---|---|---|
| US33515 | TOUCH-TYPE TRANSPARENT | Wu et al. |
| | KEYBOARD | |
| US33516 | TOUCH-TYPE TRANSPARENT | Wu et al. |
| | KEYBOARD | |
| US33517 | TOUCH-TYPE TRANSPARENT | Wu et al. |
| | KEYBOARD | |
| US33518 | TOUCH-TYPE TRANSPARENT | Wu et al. |
| | KEYBOARD | |
| US33519 | TOUCH-TYPE TRANSPARENT | Wu et al. |
| | KEYBOARD | |
| US33520 | TOUCH-TYPE TRANSPARENT | Wu et al. |
| | KEYBOARD | |

### BACKGROUND

1. Technical Field

The present disclosure generally relates to touch-type transparent keyboards, and particularly, to a touch-type transparent keyboard for use with an electronic device.

2. Description of Related Art

For operating electronic devices, keyboards, mice, trackballs or remote controls are important user interfaces for controlling cursors or inputting instructions. Currently, standard mechanical keyboards are widely for use with industrial or residential fields for inputting information to computers. Mechanical keyboards may make noise while being used for typing. Moreover, the keyboards have single function, this kind of the keyboards are difficult to meet consumer demand.

Therefore, there is a room for improvement within the art.

### BRIEF DESCRIPTION OF THE DRAWINGS

Many aspects of the touch-type transparent keyboard can be better understood with reference to the following drawings. The components in the drawings are not necessarily to scale, the emphasis instead being placed upon clearly illustrating the touch-type transparent keyboard. Moreover, in the drawings, like reference numerals designate corresponding parts throughout the several views.

FIG. 1 is a partially exploded and isometric view of a touch-type transparent keyboard, according to an exemplary embodiment.

FIG. 2 is an assembled view of the touch-type keyboard.

FIG. 3 is a cross-section view of a touch screen of the touch-type transparent keyboard shown in FIG. 1.

FIG. 4 is an assembled, isometric view of the touch-type transparent keyboard of FIG. 2.

FIG. 5 is an assembled, isometric view of a touch-type transparent keyboard, according to another exemplary embodiment.

### DETAILED DESCRIPTION

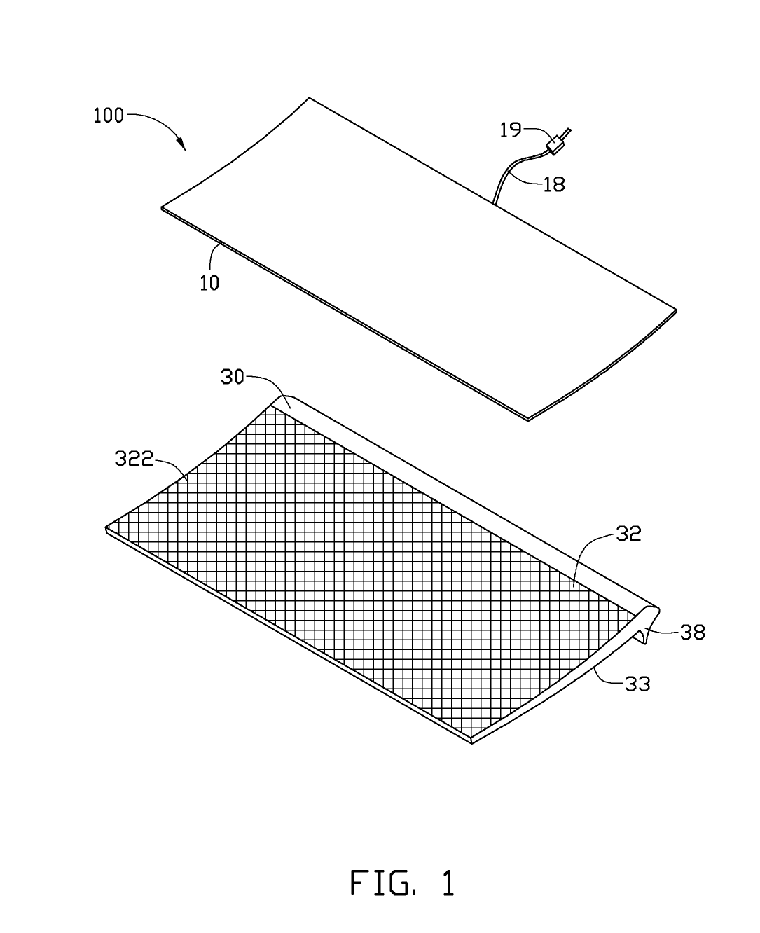

Referring to FIG. 1, the present disclosure provides a touch-type transparent keyboard 100 for use with an electronic device. The electronic device includes but is not limited to a smart phone, a mobile phone, a personal digital assistant (PDA), an e-book reader, or a notebook computer. In an exemplary embodiment, the touch-type transparent keyboard 100 includes a touch screen 10 and a transparent plate 30. The touch screen 10 is connected to the transparent plate 30. Using a finger or a stylus to touch the touch screen 10, users can input an instruction to control the electronic device.

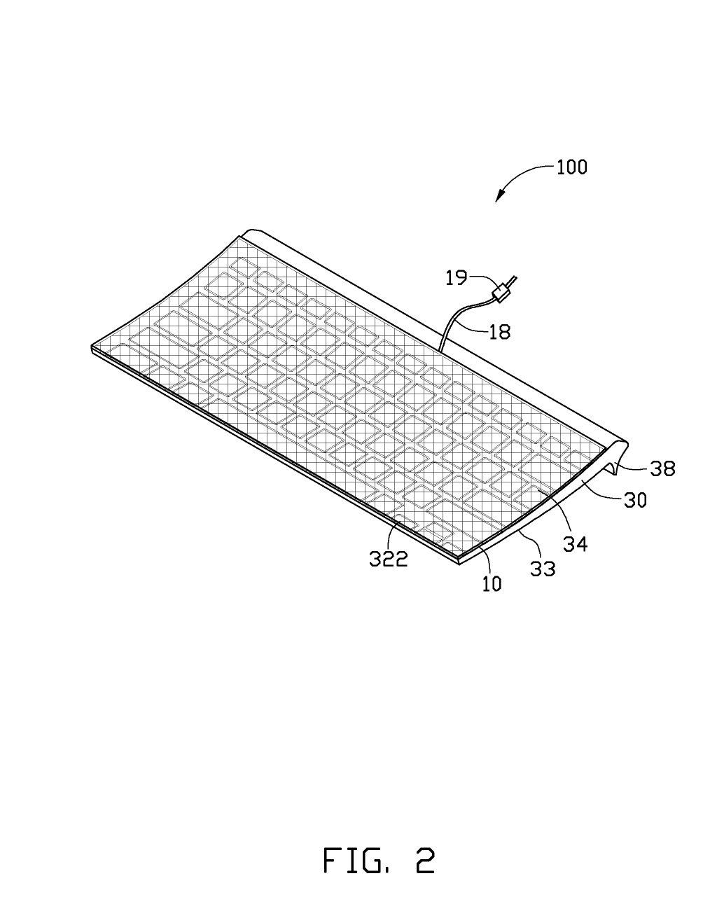

Referring to FIG. 2, the touch screen 10 may be a transparent capacitive touch screen including a transparent protective layer 12, a first conducting layer 14, a transparent main body 16, a second conducting layer 17, a connecting wire 18, and a control module 19. The transparent protective layer 12 may be made of silicon dioxide (SiO) or polyethylene terephthalate (PET). The first conducting layer 14 is attached to the transparent protective layer 12, and may be made of indium tin oxide (ITO), aluminum-doped zinc oxide, or cadmium oxide (CdO). The first conducting layer 14 is configured for detecting a touch position. The transparent main body 16 is attached to the first conducting layer 14, and may be made of transparent glass or transparent plastic. The second conducting layer 17 is coated on the transparent main body 16, and may be made of transparent conducting material for shielding the transparent main body 16. The connecting wire 18 connects the touch screen 10 to a computer. The control module 19 may be an integrated chip disposed on the connecting wire 18 and is electrically connected to the first conducting layer 14, the second conducting layer 17 and the connecting wire 18 by flexible cables. When the users touch the transparent protective layer 12, the control module 19 can detect a touch position coordinate made by the users, and produce a corresponding command signal to the electronic device.

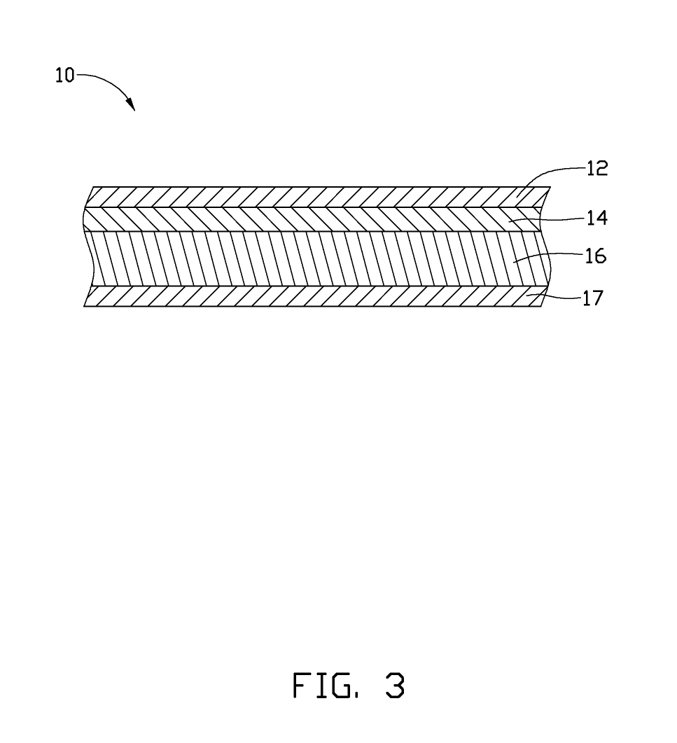

Referring to FIG. 3, the transparent plate 30 can be made of transparent glass or transparent resin, and is configured for supporting the touch screen 10. The transparent plate 30 includes a first surface 32 and an opposite second surface 33. The first surface 32 may be adhered to the second conducting layer 17. A metal film 322 is attached to the first surface 32. The metal film 322 uses titanium, nickel, copper, or chromium as a target, then is formed on the transparent plate 30 by a vacuum evaporation, a sputtering, or an ion injection method, so that the metal film 322 generates a mirror effect. In the exemplary embodiment, the target is made of titanium.

A plurality of key icons 34 and a driver circuit 36 are disposed on the second surface 33 of the transparent plate 30. The key icons 34 are made of transparent electroluminescence material printed or spraying on the second surface 33. The key icons 34 can illuminate when the touch-type transparent keyboard 100 is powered on. An original coordinate information of the key icons 34 is stored in the control module 19 corresponding to touch portions of the touch screen 10. By touching the key icons 34, the users can input a corresponding instruction, such as character, sign, or number to the electronic device. In response to the instruction, an image can be shown on a display of the electronic device. The driver circuit 36 can be made of transparent conducting material printed on the transparent plate 30, and electrically connecting the key icons 34 to the control module 19. The driver circuit 36 controls the key icons 34 to illuminate when it is powered on. A supporting portion 38 is positioned on the second surface 33 to support the touch-type transparent keyboard 100. In the exemplary embodiment, the supporting portion 38 is made of transparent material and a cross section of the supporting portion 38 may be substantially triangular.

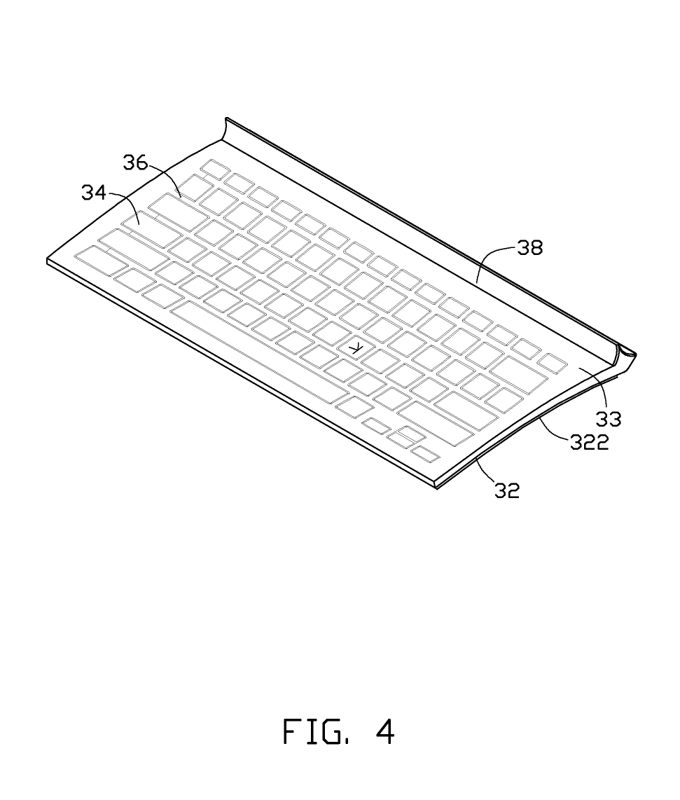

Referring to FIG. 4, when the touch-type transparent keyboard 100 is not energized, the key icons 34 does not light, and the touch-type transparent keyboard 100 does not display key icons 34. At this moment, since the metal film 322 has reflective function, the touch-type transparent keyboard 100 may be used for mirror. When the touch-type transparent keyboard 100 is powered on, the control module 19 triggers the driver circuit 36 to control the key icons 34 to illuminate and the key icons 34 are displayed through the touch screen 10. When users press the touch screen 10 hard, the control module 19 detects the touching position and records coordinate information corresponding to the touching position. Then, the control module 19 compares the coordinate information and the original coordinate information of the key icons 34 to output the command signal corresponding to the touch position.

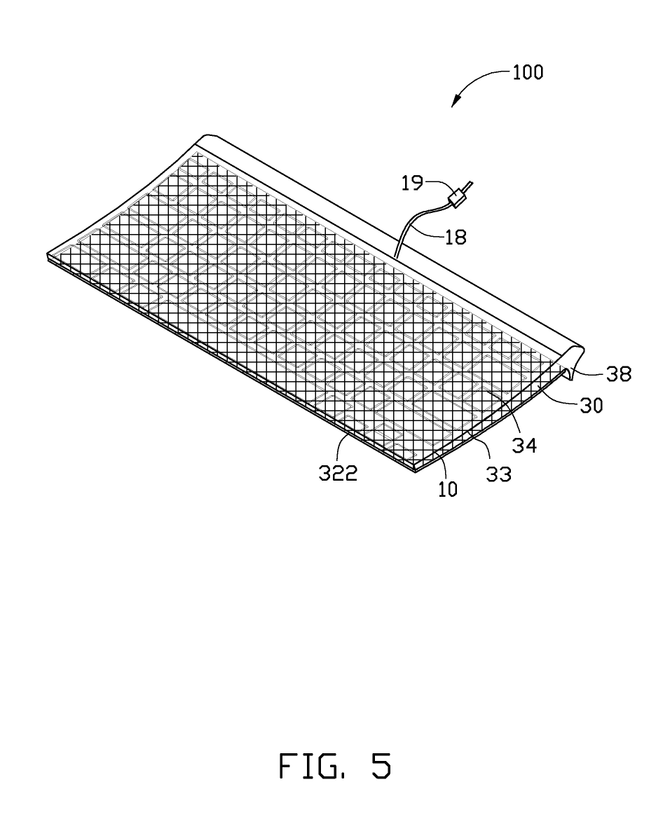

Referring to FIG. 5, in another exemplary embodiment, the metal film 322 can be located at the second surface 33. Correspondingly, the key icons 34 and the driver circuit 36 are located at the first surface 32. When the touch-type transparent keyboard 100 is powered on, the key icons 34 light and are displayed by the touch screen 10. When the touch-type transparent keyboard 100 is not energized, the touch-type transparent keyboard 100 can be used as the mirror.

In another exemplary embodiment, the metal film 322 and the key icons 34 also can be formed on the same surface of the transparent plate 30.

In another exemplary embodiment, the touch-type transparent keyboard 100 can be a wireless keyboard, the control module 19 can be disposed on a sidewall of the transparent plate 50, and made of transparent material.

In another exemplary embodiment, the touch screen 10 also can be a resistance-type touch screen or a surface acoustic wave touch screen.

The touch-type transparent keyboard 100 adopts the touch screen 10 covering on the transparent plate 30. Therefore, when typing the touch-type transparent keyboard 100, there is no noise produced. Furthermore, when the touch-type transparent keyboard 100 is not energized, the touch-type transparent keyboard 100 can be used as the mirror.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent keyboard, comprising:
a touch screen;
a control module electrically connected to the touch screen; and
a transparent plate attached to the touch screen, the transparent plate comprising a plurality of key icons made of transparent electroluminescence material, a driver circuit electrically connecting the key icons to the control module, and a metal film used to reflect light as a mirror.

2. The touch-type transparent keyboard as claimed in claim 1, wherein the transparent plate comprises a first surface and an opposite second surface, the metal film is attached to first surface, and the key icons and the driver circuit is attached to the second surface.

3. The touch-type transparent keyboard as claimed in claim 1, wherein the metal film uses titanium, nickel, copper, or chromium as a target, and the metal film is formed on the transparent plate by a vacuum evaporation, a sputtering, or an ion injection method.

4. The touch-type transparent keyboard as claimed in claim 1, wherein the driver circuit is made of transparent conducting material printed on the first surface.

5. The touch-type transparent keyboard as claimed in claim 1, wherein the transparent plate is made of transparent glass or transparent resin.

6. The touch-type transparent keyboard as claimed in claim 1, wherein the driver circuit is made of transparent conducting material.

7. The touch-type transparent keyboard as claimed in claim 1, wherein the transparent plate comprises a transparent supporting portion positioned on the transparent plate, a cross section of the supporting portion is triangular.

8. The touch-type transparent keyboard as claimed in claim 1, further comprising a connecting wire connected to the touch screen, the control module is connected to the connecting wire.

9. The touch-type transparent keyboard as claimed in claim 8, wherein the touch screen comprises a transparent protective layer, a first conducting layer, a transparent main body, a second conducting layer, a connecting wire stacked in turn; the control module electrically connects to the first conducting layer, the second conducting layer, and the connecting wire.

10. A touch-type transparent keyboard for use with an electronic device, the touch-type transparent keyboard comprising:
a touch screen;
a control module electrically connecting to the touch screen; and
a transparent plate comprising a plurality of key icons and a metal film, the transparent plate attached to the touch screen;
wherein when a touching position corresponding to the key icons of the touch screen are touched, the control module detects a touch position coordinate and produces a corresponding command signal to the electronic device, and an image is shown on the electronic device, the metal film is used to reflect light as a mirror.

11. The touch-type transparent keyboard as claimed in claim 10, wherein the transparent plate further comprises a driver circuit electrically connecting the key icons to the control module, the control module triggers the driver circuit to illuminate the key icons the illumination of the key icons, whereby, the key icons are displayed through the touch screen.

12. The touch-type transparent keyboard as claimed in claim 11, wherein the driver circuit is made of transparent conducting material printed on the transparent plate.

13. The touch-type transparent keyboard as claimed in claim 11, wherein the transparent plate comprises a first surface and an opposite second surface, the metal film is attached to first surface, and the key icons and the driver circuit is attached to the second surface.

14. The touch-type transparent keyboard as claimed in claim 11, wherein the metal film uses titanium, nickel, copper, or chromium as a target, and the metal film is formed on the transparent plate by a vacuum evaporation, a sputtering, or an ion injection method.

15. The touch-type transparent keyboard as claimed in claim 11, wherein the driver circuit is made of transparent conducting material.

16. The touch-type transparent keyboard as claimed in claim 10, wherein the transparent plate comprises a transparent supporting portion positioned on the transparent plate, a cross section of the supporting portion is triangular.

17. The touch-type transparent keyboard as claimed in claim 10, further comprising a connecting wire connecting to the touch screen, the control module is connected to the connecting wire.

18. The touch-type transparent keyboard as claimed in claim 17, wherein the touch screen comprises a transparent protective layer, a first conducting layer, a transparent main body, a second conducting layer, a connecting wire stacked in turn; the control module electrically connects to the first conducting layer, the second conducting layer, and the connecting wire.
